(19) United States
(12) Patent Application Publication
(10) Pub. No.: US 2006/0199164 A1
(43) Pub. Date: Sep. 7, 2006

(54) Systems and methods of financing and providing education

(76) Inventor: Richard R. Murray, Wilmette, IL (US)

Correspondence Address: Bell, Boyd & Lloyd LLC, P.O. Box 1135, Chicago, IL, 60690-1135, US

(21) Appl. No.: 11/369,546

(22) Filed: Mar. 6, 2006

Related U.S. Application Data
(60) Provisional application No. 60/659,747, filed on Mar. 7, 2005.

(51) Int. Cl. G09B 3/00; G09B 7/00

(52) U.S. Cl. 434/322

(57) ABSTRACT

The present invention provides systems and methods for financing and providing education. In an embodiment according to the present invention, a method is provided for financing education. The method includes the steps of establishing a professional internship program, establishing an extension program, generating capital, and acquiring individual funds. In one embodiment, the step of establishing a professional internship program further includes the step of obtaining a sponsor contract for at least one full-time equivalent job internship position. In an embodiment, the step of establishing a extension program further includes the step of obtaining a license agreement for use of school facilities. The present invention also provides a system and method for providing education to students. The method includes the steps of securing a sponsor contract with at least one sponsor, establishing a schedule for the students where the students attend class four days per week, establishing a schedule for the students where the students work one day per week at the sponsor, providing the students with on-going training, and assigning the students to an advisory group.

### CROSS REFERENCES TO RELATED APPLICATIONS

The present application claims priority to U.S. provisional application 60/659,747 filed in the United States Patent and Trademark Office on Mar. 7, 2005, the entire contents of which are incorporated herein by reference.

### BACKGROUND OF THE INVENTION

The present invention relates generally to educational institutions. More specifically, the present invention relates to systems and methods of financing and providing education.

Secondary education in the United States generally provides instruction in grades 9 through 12, primarily for students between 14 and 18 years old. Areas of study normally include English, social studies, mathematics, science, physical education and, in some schools, elective courses which may include the arts, foreign languages or other special topics. Academic credits typically are awarded on the basis of 120 hours of classroom instruction that, in conjunction with the school's assessment of a student's satisfactory performance in that course, results in granting that student one credit hour (based on the definition of a “Carnegie Unit”). Requirements for graduation typically are a combination of a minimum total number of credits, usually about 18, and a distribution of those credits within certain subject areas, such as English where four credits of the total often are required. This basic curriculum and system is intended to prepare students either for continuing into higher education or for moving directly into lives as productive citizens, workers, and members of their communities.

Carnegie Units were first established in 1893 to assist college admissions procedures by providing uniform standards amongst the country's high schools. High schools at that time were predominantly rural with average enrollments of several hundred students. School years were approximately 36 weeks long, equal to 180 days of school. Schools scheduled classes by starting with the 120-hour standard and dividing that figure by 180 days, resulting in 40-minute class periods meeting five days per week in order to complete one Carnegie Unit by the end of the school year. School days included six to eight class periods of equal length for academic instruction, non-credit activities, and study halls which, when added to the time needed for moving between classrooms plus a lunch period, totaled about a six to seven-hour school day.

Today, secondary education in the United States still uses this fundamental system of Carnegie Units, with six to eight equal periods of classes per day. Core areas of study and graduation requirements also have changed little, although many high schools have increased the scope and amount of academic material covered during the same 120 hours of instruction. Yet during the past century most high schools have become urban rather than rural, and enrollments per school have grown into thousands of students instead of hundreds. Further, the social, economic, and technological environments in which students live, study and ultimately must work and become adult citizens have changed dramatically since the end of the 19^{th} century. For example, the average high school student today will be exposed to more than 6,000 hours of media from the time they enter high school to the day of graduation.

Recent research has brought about a much greater understanding of brain development and chemistry during this period of life when an individual's ability for rational judgment and strategic thinking first develops and begins to gain dominance over more impulsive decision-making originating in emotional centers of the brain. Further, much more is understood about multiple types of intelligence and how they affect the acquisition of knowledge and critical thinking skills that are increasingly important for success in modern society.

Research on learning also has identified four major categories of learning methods including: learning from teachers or experts, learning from peers, learning from oneself, and learning from experience in the larger world (outside the school). In this latter category, studies have proven the increasing importance and effectiveness of experiential or “hands on” learning, with examples ranging from conventional laboratory activities to various forms of internship experiences. Many other important types of learning activities, in addition to the traditional classroom lecture format, have been identified such as project-based study, team teaching, collaborative group study, seminars, peer tutoring, one-on-one learning with a teacher, performance-based learning, independent study, technology-based learning, storytelling, and distance learning.

The 100-year old system of secondary education does not offer much flexibility for using this greater understanding of human development and learning. New, educational methods often do not fit within the Carnegie Unit structure and short class periods. Yet, contrary to this greater understanding of learning, many schools, in an effort to improve results on standardized testing, have actually moved toward more memorization rather than development of critical thinking skills. Many large urban high schools, because of this approach and their size, have become bureaucratic institutions characterized by large class sizes and an emphasis on the control and efficient movement of students through a process of preparing for tests and collecting credits for graduation. Workloads for students and faculty are high, subject materials are not necessarily relevant to the world students will face upon graduation, and opportunities for developing critical thinking skills are rare.

Limited funding for secondary education only exacerbates the academic system's structural flaws. Educational funding during the past 100 years has changed no more than the academic system of standardized credits and class schedules. Public high schools typically receive their capital and operating funds from combinations of federal, state, and local government sources. These sources are constrained by the sizes of their tax bases, statutory limitations on tax rates, political influences on budgetary decisions, and, in the case of capital funding, the credit capacities of the relevant governmental units. These governmental sources are subject to local economic conditions that can result in noticeable disparities between even neighboring school communities. National economic conditions also cause fluctuations in funding over periods of time.

Private high schools are funded differently than public schools, but they also have changed little over the years. Private schools still receive the majority of their operating funds from student tuition and, to varying degrees, from private donations. Capital funding typically comes almost entirely from private donations. Funding for private high schools is even more sensitive to economic conditions that affect the affordability of tuition and the competition with other educational and charitable organizations for private donations. Financial insecurity is not uncommon for teachers, staff, and even the schools themselves, which in turn undermines even the best efforts to deliver a quality education for the students.

Limitations on funding for both public and private high schools can result in diminished quality of learning environments through: under staffing; low teacher compensation and benefits; outdated teaching materials and inadequate supplies; lack of modern technological and support equipment; deferred maintenance on existing facilities; and delayed construction of new facilities. Additionally, inadequately funded schools typically cut programs outside of the core academic subjects, such as performing or visual arts, sports teams and clubs, technology, counseling, health services, college or career preparation and counseling, after school and summer programs, and outside resources such as field trips or lectures. Unfortunately, these types of additional programs may help foster precisely the social, emotional, and intellectual growth that is needed.

Secondary education in the United States is based on assumptions and systems that may have had relevance 100 years ago, but for many of its students today it is not providing the quality of education needed to produce good and productive citizens with opportunities for college and the ability to make a living. Evidence of this failure can be found most directly in the drop out rates at some large public high schools which can run as high as 60% to 70%.

### SUMMARY OF THE INVENTION

The present invention provides systems and methods for financing and providing education. In an embodiment according to the present invention, a method is provided for financing education. The method comprises the steps of establishing a professional internship program by obtaining a sponsor contract with a sponsor for a full-time equivalent job internship position, establishing an extension program by obtaining a license agreement for use of school facilities, establishing a capital campaign, and acquiring individual funds.

In one embodiment, the individual funds are in the form of tuition charged to the student. In another embodiment, the individual funds are vouchers. Vouchers may include public or private vouchers, grants, or scholarships. In another embodiment, the individual funds are government funds. In yet another embodiment, the individual funds include charter funds given to the school from the local, state, or federal government.

In one embodiment, the extension program licenses the use of school facilities. School facilities may include athletic facilities, classrooms, laboratories, libraries, media centers, fine art spaces, performing arts spaces, technology centers, and related equipment and services.

The present invention also provides a method for providing education to students. The method comprises the steps of: securing a sponsor contract with a sponsor for an internship position where five students each work one day per week in the internship position; establishing a schedule for the students where each of the students attends class four days per week; establishing a schedule for the students wherein each of the students work one day per week in the internship position; and providing the students with on-going training.

In one embodiment, the students attend class at another institution. In another embodiment, the students attend class over the Internet.

In one embodiment, the sponsor is a business entity. In another embodiment, the sponsor is the school or one of its subsidiaries. In another embodiment, the sponsor is a not-for-profit entity or a government entity.

In one embodiment of a method of providing education, the on-going training for some students includes extra training.

In one embodiment, the method further includes the step of assisting the students to develop an individual learning plan. In another embodiment, the method further includes the step of assigning the students to an advisory group wherein the students meet in the advisory group with a faculty member on a periodic basis. In an embodiment, the students are assigned to the same advisor and advisory group throughout their enrollment at the school.

In one embodiment of the method of providing education, the school or professional internship program provides an incentive for students to attend college. In one embodiment, the method includes the step of funding a personal college fund from the student's salary earned in the professional internship position. In another embodiment, the school forms a college incentive program which provides the students with direct subsidies for college or college loan repayment assistance upon graduation from college or successful completion of an academic period.

In an embodiment of the present invention, a system of financing education is provided. The system includes a professional internship program and an extension program. The professional internship program is established by obtaining a sponsor contract with a sponsor for an internship position. The extension program is established by obtaining a license agreement for the use of school facilities. The system further includes a capital campaign and a mechanism for acquiring individual funds. The mechanism for acquiring individual funds could be a computer server such as an Internet server. Alternatively, the mechanism for acquiring individual funds could be a program established by the school to ensure that the individual funds are collected from the necessary sources.

Additional features and advantages of the present invention are described in, and will be apparent from, the following Detailed Description of the Invention and the figures.

### BRIEF DESCRIPTION OF THE FIGURES

FIG. 1 is flow-chart of an embodiment for financing education according to the present invention.

FIG. 2 is a flow-chart depicting an embodiment of a professional internship program according to the present invention.

FIG. 3 is a flow-chart of an embodiment of providing education according to the present invention.

FIG. 4 is a table of an embodiment of providing education according to the present invention.

FIG. 5 is a flow-chart of an embodiment of providing education according to the present invention.

FIG. 6 is a flow-chart of an embodiment of financing education according to the present invention.

FIG. 7 is a flow-chart of an embodiment of financing education according to the present invention.

FIG. 8 is a flow-chart of an embodiment of financing education according to the present invention.

### DETAILED DESCRIPTION OF THE INVENTION

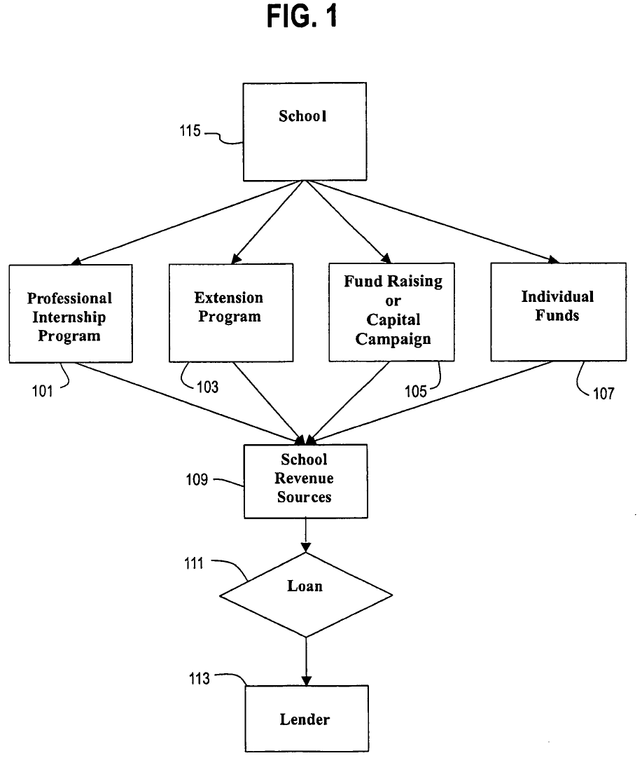

Referring now to the figures, FIG. 1 is a flow-chart of one embodiment of the present invention directed towards a system and a method of financing education. As depicted, a school 115 uses school revenue sources 109 to secure a loan 111 by a lender 113. The loan or loans 111 may be any type of loan, including a mortgage or business loan, or as credit enhancement in support of bond financing, which is used to, among other things, build school facilities or to finance the school's daily operations. The lender or lenders 113 may be any type of financial institution that provides funding, especially funding for businesses or educational entities.

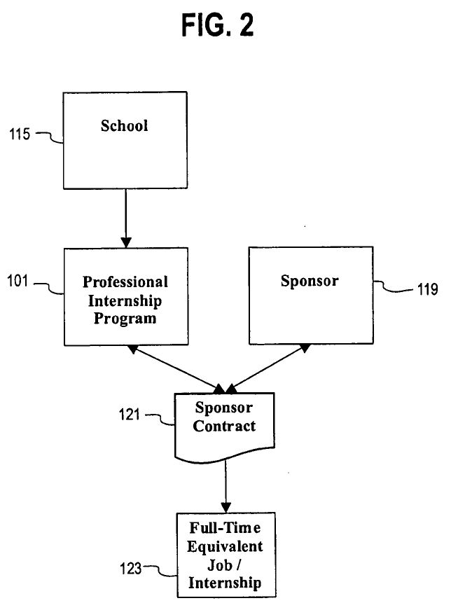

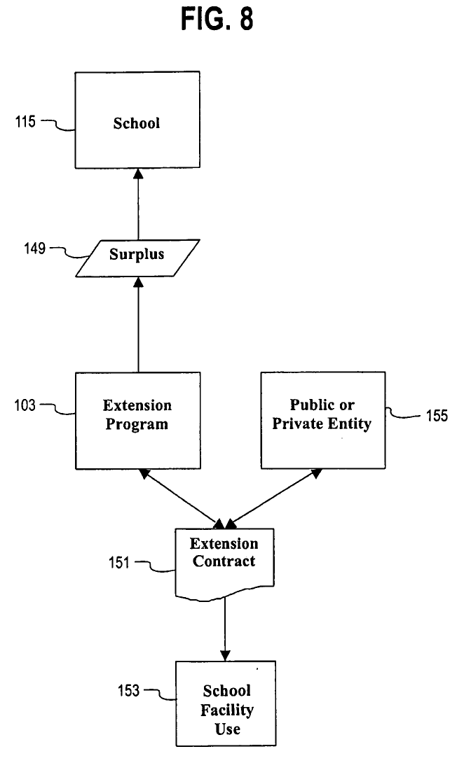

The sources of revenue 109 for a school's capital finance include a professional internship program 101, an extension program 103, fund raising campaign 105 (also sometimes known as a capital campaign when applied to capital improvements), and individual funds 107. The school 115 owns or controls two subsidiary entities, a professional internship program 101 and an extension program 103. Embodiments of the professional internship program 101 and the revenue generated therefrom are discussed in more detail below in regards to FIGS. 2 through 7. Embodiment of the extension program 103 are discussed below in regards to FIG. 8.

In addition to the professional internship and extension programs, a school can generate a capital campaign 105, including capital campaign estimates, to assist in securing a loan to finance the school. The capital can be any form of capital that the school is capable of raising, such as donations or money from fund-raisers. The capital may include existing funds if the school already has a reserve of funds or property holdings. Capital campaign estimates can also be used to secure a loan. These estimates be based on pledges or donations from alumni or the community. These projections are often made through professional feasibility studies.

In one embodiment of the present invention, another source of revenue is individual funds 107. Individual funds are sources of revenue that are associated with individual students, such as tuition, charter funds, or vouchers.

In one embodiment, the individual funds are student tuition. Tuition is a fee charged to students for educational instruction. Private schools may charge tuition for instruction. In one embodiment, the tuition is paid-in-full up front by the student. In another embodiment, as discussed below, the student pays in installments. The installment payments can come from either family members, friends, or the like, and/or from the student's salary earned from the professional internship program. Many states offer parents tax credits and/or deductions for expenses paid for a child's education, including tuition. A tax credit provides direct reductions to a parent's tax liability. A tax deduction is a reduction in taxable income made prior to the calculation of tax liability.

In another embodiment, the individual funds are in the form of a voucher. A voucher is an entitlement to education, usually in the form of a specified amount of money, issued to a student or their parent and redeemable for the provider of education of the student's choice. Students may use a voucher to attend a public, private, or charter school of their choice. A voucher as used herein can take the form of a public voucher, a private voucher, a grant, or a scholarship.

A publicly funded voucher is a payment the government makes to a parent, or an institution on a parent's behalf, to be used for a child's education expenses. The publicly funded voucher can come from the local, state, or federal government. In one embodiment, the voucher has no restrictions, therefore, the parent may enroll the child in any public or private school of their choice. In another embodiment, the voucher is good for education only within the jurisdiction of the voucher granting entity. For example, a state may give a parent $5,000 to apply towards their child's education for the year, for use at a school within the state borders. The parent can then choose to send the child to a private school, and have the $5,000 voucher applied towards the private tuition. Additionally, in one embodiment, if the parent chooses to send the student to a public school, which requires no up-front fees, the parent is able to receive a tax credit or reduction up to the amount of the voucher for educated related expenses, such as extracurricular activities, fees, books, transportation, or computers.

A privately funded voucher is a payment that a private organization makes to a parent, or an institution on a parent's behalf, to be used for a child's education expenses. For example, a business may offer its employees vouchers for their children's education as a benefit of employment. The private vouchers also may or may not contain restrictions on where they can be used.

A grant is a financial need-based form of government assistance that is usually administered in conjunction with the federal student loan programs. Typically, they are awarded on a financial need basis and do not have to be repaid.

Scholarships, like grants, are also a form of assistance that does not have to be repaid. Scholarships are usually awarded based on merit as opposed to financial need. Scholarships usually come from private sources, such as civic and religious groups or individual schools, although there are some state and federal scholarships. Scholarships may have certain requirements that must be met, such as maintaining a certain grade-point average, participating in certain activities, or completing specific courses.

In another embodiment, the individual funds are government funds. In one embodiment, government funds are funds provided to the school by the local, state, or federal government for the operation of a public school.

In another embodiment, the government funds are charter funds. Charter funds are funds provided by the city, county, state, or other government entity to assist in the creation and financing of a charter school. Charter schools are public or private schools that operate in accordance with state law but are exempt from significant state or local rules that normally govern the operation and management of public schools. They are created as a public or private school, or are adapted from an existing public or private school, and are operated under public or private supervision and directions. They operate in pursuit of a specific set of educational objectives determined by the school's developer and agreed to by the public or private chartering agency. For example, a developer may create a school that, in addition to providing regular curriculum, specializes in musical training for students with an aptitude for music.

FIG. 2 is a flow-chart depicting one embodiment of a professional internship program. A school 115, school system, or developer establishes a professional internship program 101. In one embodiment, the professional internship program is a subsidiary of the school, structured as a charitable organization. In another embodiment, the professional internship program subsidiary is structured as a corporation, such as an S corporation or a limited liability corporation. Alternatively, the professional internship program can also be formed and administered by the school directly. It should be appreciated that any legal structure of the professional internship program is contemplated.

In one embodiment, the professional internship program 101 administers an internship program at the school 115 whereby the students get work experience at a sponsor 119. The sponsor 119 can be any entity that is able to provide the students with work experience, such as a business, government agency, not-for-profit entity or charitable organization, or the school or one of its subsidiaries, such as the professional internship program itself or an extension program. The professional internship program 101 and the sponsor 119 enter into a sponsor contract 121 whereby the sponsor agrees to pay the program for the services of the students for a full-time equivalent job internship position 123, which is detailed below. In a preferred embodiment, the sponsor contract is a multiple-year contract. However, in another embodiment, the sponsor contract may be for a period of a year or less, such as a school year or a semester. In an embodiment, the sponsor contracts are for multiple full-time equivalent positions. For the school's financing purposes, lenders and credit enhancers can lend in part against the established credit of the sponsors 119 under contract 121 with the professional internship program 101.

In one embodiment, the professional internship program enters into a long-term sponsor contract with just one sponsor. In one embodiment, the sponsor contract requires the sponsor to set aside a large number of entry-level positions for the school interns. A large business entity in a community can generate good-will and valuable exposure within the community by funding a local school and providing education and work experience to a number of local students. For example, a sponsor could agree to a ten-year contract whereby it sets aside fifty entry-level jobs to be filled by students at the school. In addition to the good-will and exposure, the business entity would be provided with a large pool of workers from which to select potential future employees from. In another embodiment, the same concept is used but with a select few sponsors entering into long-term agreements with the professional internship program.

In one embodiment, the students are employees of the professional internship program, not the participating sponsors. The professional internship program thus administers all payroll, W-4, I-9, FICA, work permits, and other employer issues.

Sponsors, for income tax purposes, may not treat their sponsor contract expenditures as charitable contributions even though these expenditures may be passing to the school or one of its subsidiaries that may be a charitable organization because the sponsor is receiving services in exchange for the expenditure. Instead, sponsors may treat these expenditures as standard business expenses thus typically providing greater tax advantages to the sponsor than if the expenditures were treated as charitable contributions.

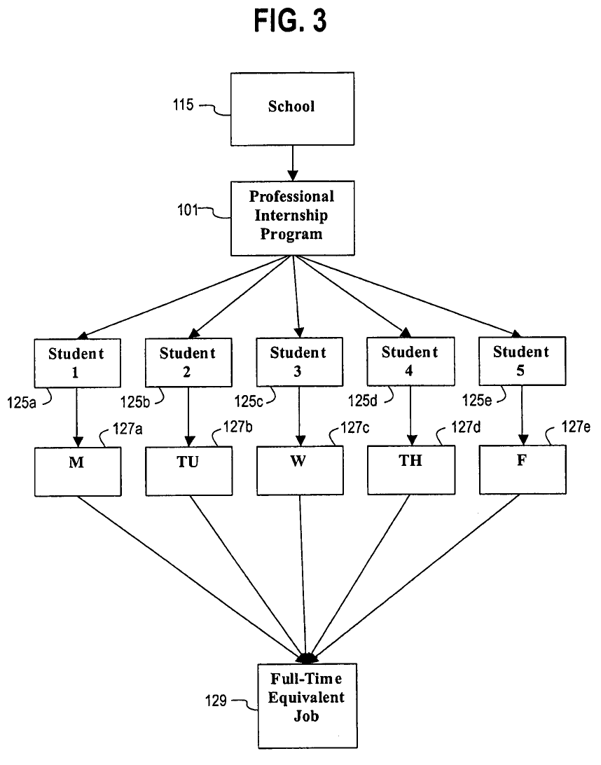

Referring now to FIG. 3, an embodiment of the present invention of a system and a method of providing education is detailed. As disclosed above with regards to FIG. 2, a school 115 establishes a professional internship program 101 whereby students 125a-e work at a sponsor business. As depicted by blocks 127a-e, five students 125a-e share one full-time equivalent job 129, or internship, each working a different day of the week. For example, in one embodiment, student one 125a works Mondays 127a, student two 125b works Tuesdays 127b, student three 125c works Wednesdays 127c, student four 125d works Thursdays 127d, and student five 125e works Fridays 127d. In another embodiment, a student may work on a weekend day.

In one embodiment, the student is allowed to choose the sponsor that he or she wants to intern for. In another embodiment, the student ranks the sponsors and the assignments are given out based on the student's rankings and preferences. For example, students with an interest in law are given preference for positions with sponsors in the legal community, such as law firms or government entities. Students with an interest in medicine are given preference for positions with sponsors in the medical community. In another embodiment, the students rotate internship positions on a periodic basis. For example, the program could be setup wherein the students work at different sponsors during successive school semesters. This approach provides the students with a broad perspective of employment and career possibilities while engaging student's minds and nurturing curiosity.

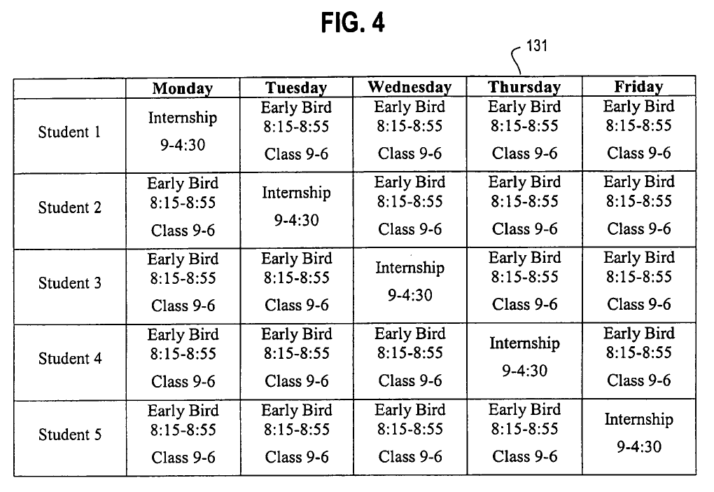

As depicted in FIG. 4, students attend class four days per week and work at the internship position one day per week. Table 131 details a schedule for the students in one embodiment. The work/school week is Monday through Friday. Five students each work one day per week at the internship position. Students attend classes during the other four days on a block schedule with slightly longer school days, achieving the required annual hours of class time to satisfy state education and accreditation requirements. In one embodiment, students attend class from 9 A.M. until 6 P.M., four days per week, and work 9 A.M. until 4:30 P.M. at their internship positions one day per week. In one embodiment, in addition to attending classes at his or her own school, the student attends classes at another institution, such as another school, a local college for college or dual credit, at a museum or other cultural institution, or over the Internet.

Academic schedules in an embodiment are structured by the school whereby students work at the professional internship without missing classes. For example, each class has multiple sections that only meet four or fewer days per week. Students in each section are able to work at their internship without having to make up lost class work or class time.

In one embodiment, the students attend periodic or on-going training sessions in order to prepare students for their internships, college, or post-graduation work. These training sessions are training classes or instruction that continues throughout the educational career of the student while in the professional internship program. For example, in one embodiment as depicted in table 131, the students may attend training sessions as a class during the normal class period of 9:00 A.M. to 6:00 P.M. on one or more days of the week or during the early bird sessions, as discussed below, from 8:15 A.M. to 8:55 A.M. during the week when not at their internship assignments. Multiple types of schedules can be arranged to provide the periodic and on-going training.

The training sessions can be taught by either the school faculty, adjunct expert instructors, or by the sponsors themselves. The training sessions generally teach business and more general “survival” skills suited to the modern environment. Training and study may include a wide range of topics, from general business skills, etiquette, and professionalism to time management, critical path analysis, presentation skills, and consumer education. Such training may also include college and/or career counseling, and substantive topics geared toward a particular job or industry. For example, students working in the legal field can be given training sessions on the judicial system and law firm administration. Another training session can prepare the students to transfer their skills to a post-graduation job.

In one embodiment, students attend a “freshman boot camp.” That is, new or first year students get extra training before or during their first work assignment or school year, where they learn a variety of topics which are designed to: 1) instill the necessary work ethic; 2) alleviate any fear or apprehension about the internship program; and 3) ensure that the sponsors are immediately provided value by the students. In one embodiment, the student attends extra sessions per week. In another embodiment, the training sessions extend for a longer period of time. Multiple types of schedules can be arranged to provide the extra training.

In another embodiment, there are optional enrichment or required remedial sessions. For example, in one embodiment these sessions are “early bird” sessions that take place before school every day. At these sessions, students are given extra training and help in various subjects and areas. The sessions can be for such subjects, among others, as advanced or remedial academic study or technology training, independent project work, counseling, physical education or health training.

In one embodiment, the school works with the student to develop an “individual learning plan.” An individual learning plan is a schedule for the student that is individualized to the student's needs and/or interests. Preferably, the individual learning plan is created at the end of the junior year, whereby the student works with an advisor or counselor to tailor his or her senior year schedule to his or her interests and goals. For example, the individual learning plan in one embodiment includes plans for classes, projects, independent studies, college prep counseling, and after-school activities, such as competitive sports or sport clubs, musical clubs, or scholastic clubs. In one embodiment, the student fulfills a portion of his or her academic requirements at another school, a local college for college credit, or over the Internet.

In one embodiment, the school forms an advisory group for the students. An advisory group is a relatively small group of students that meet on a periodic basis to discuss various administrative, academic, and social issues with a faculty advisor. Preferably, the same group of students meets together throughout their career at the school with the same advisor. For example, if the advisory group was created at a typical high school, grades nine through twelve, the same group of students would meet together on a periodic basis, such as once a week or month, or each of four days per week, throughout their four years at the school. In the advisory group session of one embodiment, students receive notices about school events, register for classes, sign up for activities, or meet with other school faculty and officials. The advisory group sessions are advantageous because in the method of providing education of the present invention, about 20% of the students are absent on any given day working at their internship positions. Therefore, school wide announcements and discussions may be difficult. The advisory group sessions offer an environment for students to ask questions, such as those relating to school, home life, or future employment or educational opportunities. By periodically meeting with the same small group of students, the faculty advisor gets to know the students individually and may develop a close relationship with the students where they are able to notice opportunities, needs or problems at an earlier stage. This relationship gives the students and their families a first contact at the school that they can go to for help and guidance. It also gives the remainder of the faculty a contact that they can go to see if there might be personal problems with a student.

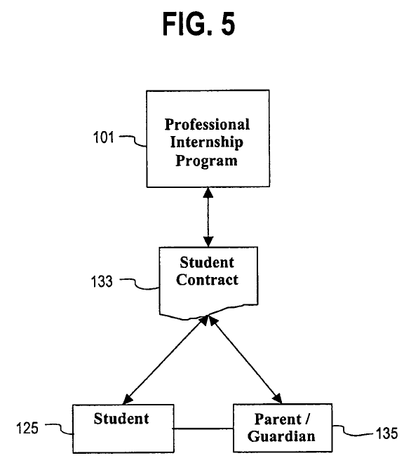

Referring now to FIG. 5, the professional internship program 101 enters into a student contract 133 with both the student 125 and the student's parent or guardian 135. Because most students are minors, the student contract generally must be signed by the parent or guardian 135 in order to be valid. A benefit of a requirement of having the student and their parent or guardian sign the contract is that the parents are fully educated as to the requirements and responsibilities of the program. In one embodiment, the contract obligates the student to work one day per week at a sponsor and requires the student to assign a percentage of their pay to the school for payment of tuition. Preferably, the student assigns 100% of their pay to the school in order to pay their tuition bill. In another embodiment however, a student may keep a portion of their salary. In yet another embodiment, the contract allows the student to contribute a portion of their salary to a personal college fund as discussed below.

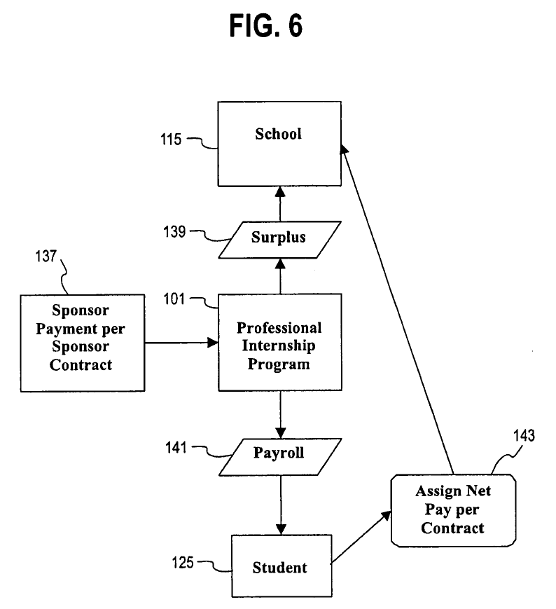

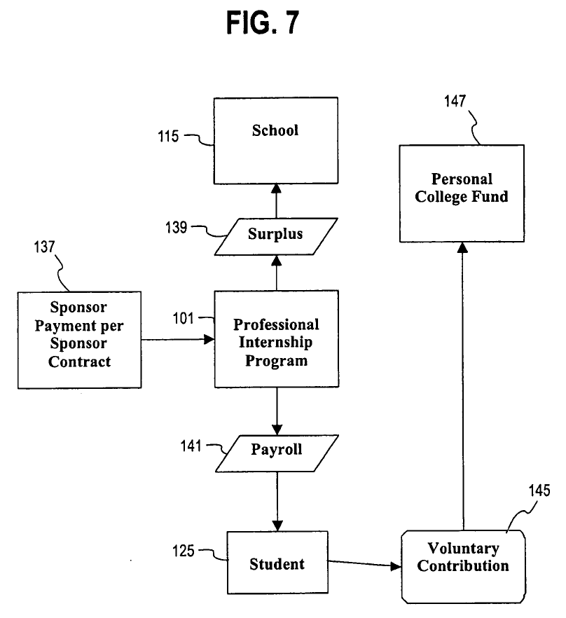

FIGS. 6 and 7 are flow-charts of embodiments of systems and methods of financing education or providing education utilizing a professional internship program according to the present invention. As depicted in block 137, the professional internship program 101 receives payment per the sponsor contract. As shown in block 139, the professional internship program assigns any surplus over to the school 115. This surplus serves as a source of revenue for the school for funding its operations or securing a loan. The surplus can be a predetermined amount of money based on the sponsor contracts, or it can be variable based on the operating surplus of the professional internship program.

In one embodiment, the student contract calls for the student 125 to receive a salary from the payroll 141 for their internship work, with the requirement that the salary then be signed over to the school for satisfying tuition obligations as depicted by block 143 in FIG. 6. In another embodiment, the student may keep a percentage of their salary. For example, the contract may allow the student to sign over half of the salary to the school for tuition obligations, with the student being allowed to either keep the other half or invest into a personal college fund.

Referring to FIG. 7, in another embodiment, as depicted by block 145, the student voluntarily contributes a percentage of their pay to a personal college fund 147. In one embodiment, the personal college fund 147 builds as long as the student attends the school 115. Upon graduation from the school 115, the student is able to withdraw money from the fund to apply towards college tuition. In one embodiment, either the professional internship program, school, or third-party foundation contributes additional money into the college fund to apply towards college tuition. For example, a foundation could contribute two dollars for every dollar that the student voluntarily contributes into his or her personal college fund. This additional money could then be used for up-front college expenses or for assistance in the payback of student loans.

In another embodiment, the school forms a college incentive program. The college incentive program either provides direct subsidies for college or assists students in paying off their college loans upon graduation from college, or upon their successful completion of an academic period. This type of college fund provides an incentive for students to attend and/or finish college. In one embodiment, the professional internship program sets aside a portion of its annual revenues into a college incentive program. Students who graduate from the school meeting reasonable academic and behavioral standards, and who graduate from an accredited college program within a reasonable amount of time, qualify for financial assistance from the college incentive program to pay off the student's college loans. In one embodiment, the school assists the student in paying off their student loans over an extended period of time, up to the amount of tuition paid to the school. For example, if the student paid a tuition of $1,500 per year for four years at the school, then the school would pay up to $6,000 over a period of time, such as ten years, towards the student's college loans. In another embodiment, the school pays a fixed amount per successful academic period completed by the student.

FIG. 8 illustrates an embodiment of a system or method of financing or providing education that utilizes an extension program. In an embodiment, the extension program 103 is a subsidiary of the school 115, structured as a charitable organization. In another embodiment, the extension program subsidiary 103 is structured as a corporation, such as an S corporation or a limited liability corporation. Alternatively, the extension program can also be formed and administered by the school directly. In an embodiment, the extension program contracts with an outside company to act as its agent and provide management services.

As depicted by block 151, the extension program 103 and non-affiliated public or private entities 155 enter into an extension contract 151 for the use of the school facilities 153 in exchange for a fee. The extension contract is preferably a multi-year license agreement. However, in other embodiments, the extension contracts can be short-term licenses or take the form of a lease.

The public or private entities 155 are generally non-affiliated users and are predominantly governmental and tax-exempt private entities, such as athletic, recreational, cultural, and academic users.

School facility use 153 can include use of athletic facilities, classrooms, laboratories, libraries, media centers, fine art spaces, performing arts spaces, technology centers, and related equipment and services, among other possibilities.

As depicted by block 149, any surplus from the extension program flows back to the school to support its educational operations and capital needs. Contracts with public entities, such as school districts or park districts, are helpful for financing because lenders can lend in part against the established credit of the public entities. Contracts with private entities preferably must be secured with, among other things, guarantees, cash, or letters of credit to create value for financing purposes.

It should be appreciated that the above-described embodiments may be implemented using computers and related technology. For example, the school could establish a private or public Internet website to solicit donations or sponsor contracts, or to schedule events at the school's facilities. In addition, for example, the school 115 could utilize various computer programs such as spreadsheets and databases to track payroll, accounting, and scheduling. Moreover, a central server or network could be utilized to connect all or some of the programs such as the professional internship program and the extension program.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of financing education, comprising the steps of:
establishing a professional internship program by obtaining a sponsor contract with a sponsor for a full-time equivalent job internship position;
establishing an extension program by obtaining a license agreement for use of school facilities;
establishing a capital campaign; and
acquiring individual funds.

2. The method of claim 1 wherein the individual funds are tuition.

3. The method of claim 1 wherein the individual funds are vouchers.

4. The method of claim 3 wherein vouchers are selected from the group consisting of public vouchers, private vouchers, grants, and scholarships.

5. The method of claim 1 wherein the individual funds are government funds.

6. The method of claim 1 wherein the individual funds are charter funds.

7. The method of claim 1 wherein the school facilities are selected from the group consisting of athletic facilities, classrooms, laboratories, libraries, media centers, fine art spaces, performing arts spaces, technology centers.

8. A method of providing education for students at a school, comprising the steps of:
securing a sponsor contract with at least one sponsor for at least one full-time equivalent job internship position wherein five students work one day per week in the internship position;
establishing a schedule for the students wherein each of the students attend class four days per week;
establishing a schedule for the students wherein each of the students work one day per week in the internship position; and
providing the students with on-going training.

9. The method of claim 8 wherein the students attend class at another institution.

10. The method of claim 8 wherein the students attend class over the Internet.

11. The method of claim 8 wherein the sponsor is a business.

12. The method of claim 8 wherein the sponsor is the school.

13. The method of claim 8 wherein the sponsor is a not-for-profit entity.

14. The method of claim 8 wherein the sponsor is a government entity.

15. The method of claim 8 wherein the on-going training includes extra training for the students.

16. The method of claim 8 further comprising the step of assisting the students to develop an individual learning plan.

17. The method of claim 8 further comprising the step of assigning the students to an advisory group wherein the students meet in the advisory group with an advisor on a periodic basis.

18. The method of claim 8 further comprising the step of funding a personal college fund from a salary earned by the students.

19. The method of claim 8 further comprising the step of forming a college incentive program wherein the college incentive program provides the students direct subsidies for college or college loan repayment assistance upon successful completion of an academic period.

20. A system of financing education, comprising:
a professional internship program established by obtaining a sponsor contract with a sponsor for a full-time equivalent job internship position;
an extension program established by obtaining a license agreement for use of school facilities;
a capital campaign; and
means for acquiring individual funds.
